(19) United States
(12) Patent Application Publication
(10) Pub. No.: US 2005/0006626 A1
(43) Pub. Date: Jan. 13, 2005

(54) Fluorescent substance for display device

(76) Inventor: Keun Pil Lee, Gumi-si (KR)

Correspondence Address: BIRCH STEWART KOLASCH & BIRCH, PO BOX 747, FALLS CHURCH, VA, 22040-0747, US

(21) Appl. No.: 10/882,176

(22) Filed: Jul. 2, 2004

(30) Foreign Application Priority Data
Jul. 10, 2003 (KR) 46731/2003

(51) Int. Cl. C09K 11/06

(52) U.S. Cl. 252/301.16

(57) ABSTRACT

Disclosed is a fluorescent substance for a display device with much improved coverage, optical characteristics, work capacity, and yield, which is obtained by adjusting particle sizes of materials for surface treatment of the fluorescent substrate and pigment, content, and kind of the materials to be used. According to the fluorescent substance for a display device for displaying a desired image when electrons emitted from a cathode collide with a fluorescent screen formed on an anode by an accelerated applied voltage, colloidal silica is formed on the surface of the fluorescent substance, and the colloidal silica content is in a range of 0.01-0.1% of the fluorescent substance by mass.

### BACKGROUND OF THE INVENTION

1. Field of the Invention

The present invention relates to fluorescent substances for display devices, more particularly, to a fluorescent substance for display devices with much improved coverage, optical characteristics, work capacity, and yield, which is obtained by adjusting particle sizes of materials for surface treatment of the fluorescent substrate and pigment, content, and kind of the materials to be used.

2. Discussion of the Background Art

A display device makes information visible for users by converting electric signals to image signals. A typical example of such display device is a cathode ray tube for use in TVs and computer monitors.

In recently years, there is a growing need to expand or improve color reproducibility for moving images and for creation of natural colors.

The color reproducibility is controlled by coverage of a fluorescent screen in the display device. There are several expressions for defining coverage of fluorescent substances. First of all, “crack” means a part of dots of the fluorescent screen is tom loose, and “Mixing” means a particular color fluorescent substance is mixed with an area of a different color. Besides these, there are other expressions like “Cutting” and “Exposure sensitivity”.

When the crack characteristic is poor, the screen becomes defective, and bright uniformity and white uniformity are deteriorated. When the mixing problem occurs, color purity and white uniformity get worse.

To improve color reproducibility of the display device, researches are currently undergoing on the improvement of contrast and color purity by attaching pigments to red (R) and blue (B) fluorescent substances, and thus lowering reflectivity in a wavelength area that emits unnecessary colors.

The new research is advantageous over a related art glass-coloring method wherein reflectivity of the entire visible ray area's wavelengths is reduced to a constant rate. For example, it is now possible to adjust reflectivity of a selective wavelength, and to get excellent brightness under the same contrast.

FIG. 1 is a graph illustrating reflectivity characteristics of a red fluorescent substance after a pigment is attached thereto, and FIG. 2 is a graph illustrating reflectivity characteristics of a blue fluorescent substance after a pigment is attached thereto.

As shown in FIGS. 1 and 2, a fluorescent substance with a relatively high amount of pigment being attached Now reflective fluorescent substance) has 30% of reflectivity at a 550 nm wavelength area, and a fluorescent substance with a relatively less amount of pigment being attached (high reflective fluorescent substance) has 40-70% of reflectivity at the 550 nm wavelength area.

Meanwhile, reflectivity of a green fluorescent substance without pigment is approximately 80%.

However, when the fluorescent screen is formed of the pigment-rich fluorescent substance flow reflective fluorescent substance), although reflectivity can be reduced, during an exposure process the fluorescent screen can also be cracked by scattered ultraviolet rays caused by the pigment. This has a direct influence on deterioration of coverage of the fluorescent substance.

Particularly, in case of the red fluorescent substance illustrated in FIG. 1, because the reflectivity of an ultraviolet ray (below 400 nm), which is the wavelength area for a mercury lamp used for the exposure process, is low, a great amount of ultraviolet rays is absorbed and this in turn deteriorates exposure characteristics and makes a crack on the fluorescent screen.

On the other hand, many manufacturers often make haste with coating and injecting a fluorescent substance slurry to shorten manufacturing time, and try to reduce exposure time as much as possible. In so doing, they are not giving a sufficient time for the fluorescent substance slurry to glue to a panel in a proper way but only gives a bad effect on the coverage of the fluorescent substance.

In addition, the structure of the related art fluorescent screen is usually closely packed. This is because the fluorescent surface is treated with hydrophilic type material, and poorly dispersed on the slurry.

As illustrated in FIG. 3, when the fluorescent screen has the close packing structure, ultraviolet rays are scattered during the exposure process, and the amount of exposure at a central portion of a dot lacks. Therefore, as shown in FIG. 4, the central portion of the fluorescent dot is cracked and fallen out.

Table 1 below shows materials for surface treatment of the related art fluorescent substance and contents thereof.

TABLE 1

| Gelatin | Arabic Gum | Silica | ZnSO₄ (20%) | HPC |
|---|---|---|---|---|
| 0.4-1.0 g | 0.2-0.8 g | 0.05-0.15% | 0.05-0.5 g | 0.05-0.5 g |

As shown in the Table 1, the surface of the related art fluorescent substance is often treated with colloidal silica having a large particle size, but it turned out usage of such material only worsens coverage of the fluorescent substance.

That is, when the colloidal silica with a large particle size is used as illustrated in FIG. 5, a great amount of ultraviolet rays is scattered during the exposure process, and cross linkage between Polyvinyl alcohol (PVA) and a photosensitive agent is weakened. Therefore, as shown in FIG. 6, the fluorescent dot is cracked. Also, as a result of light scattering, cutting of the fluorescent substance becomes worse.

### SUMMARY OF THE INVENTION

An object of the invention is to solve at least the above problems and/or disadvantages and to provide at least the advantages described hereinafter.

Accordingly, one object of the present invention is to solve the foregoing problems by providing a fluorescent substance for a display device with remarkably improved coverage, optical characteristics, work capacity, and yield, which is obtained by adjusting particle sizes of materials for surface treatment of the fluorescent substrate and pigment, content, and kind

The foregoing and other objects and advantages are realized by providing a fluorescent substance for a display device for displaying a desired image when electrons emitted from a cathode collide with a fluorescent screen formed on an anode by an accelerated applied voltage, wherein colloidal silica is formed on a surface of the fluorescent substance, and the colloidal silica content of the fluorescent substance is in a range of 0.01-0.1% by mass.

Another aspect of the invention provides a fluorescent substance for a display device, wherein size of a pigment attached to a surface of the fluorescent substance is in a range of 100-240 nm, and particle size of colloidal silica is in a range of 8-40 nm

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a graph illustrating reflectivity characteristics of a red fluorescent substance after a pigment is attached thereto;

FIG. 2 is a graph illustrating reflectivity characteristics of a blue fluorescent substance after a pigment is attached thereto;

FIG. 3 illustrates a fluorescent screen having a close packing structure;

FIG. 4 illustrates a phenomenon in which a central portion of a fluorescent substance dot is cracked and fallen off;

FIG. 5 illustrates usage of colloidal silica having a large particle size;

FIG. 6 illustrates a phenomenon in which a fluorescent substance to which colloidal silica having a large particle size is attached is cracked;

FIG. 7 is a graph illustrating a relation between reflectivity and wavelength;

FIG. 8 illustrates a case that coverage of a fluorescent substance is improved by adjusting pigment size and particle size of colloidal silica;

FIG. 9 illustrates a fluorescent screen in a good condition by applying a fluorescent substance of FIG. 8;

FIG. 10 illustrates a fluorescent screen having a rough packed structure; and

FIG. 11 illustrates a roughly packed fluorescent screen without crack.

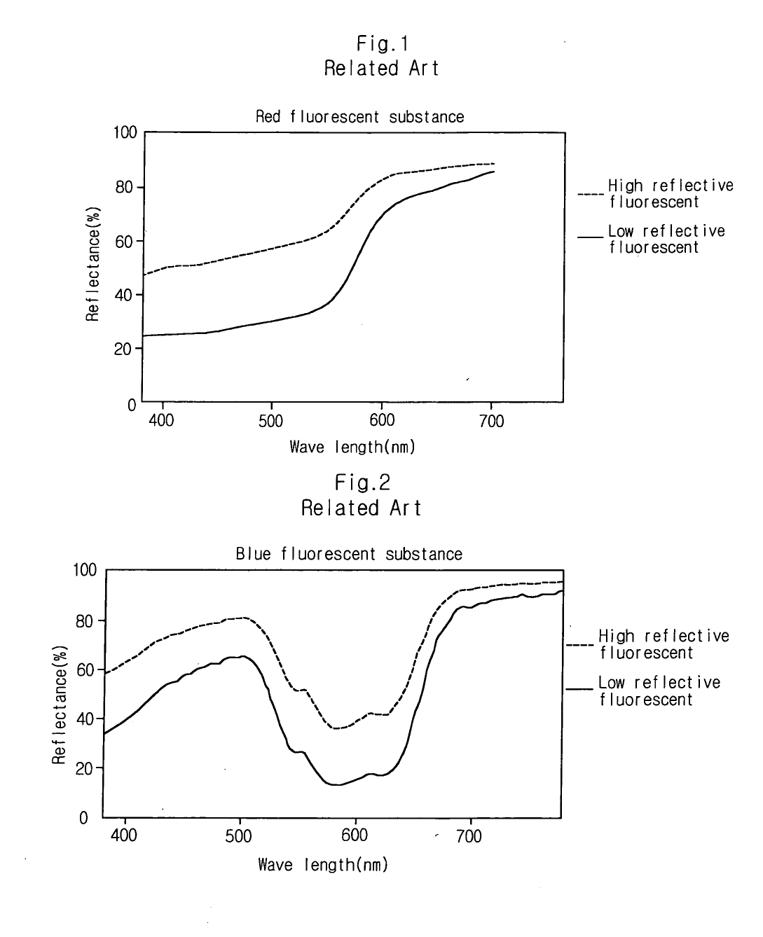

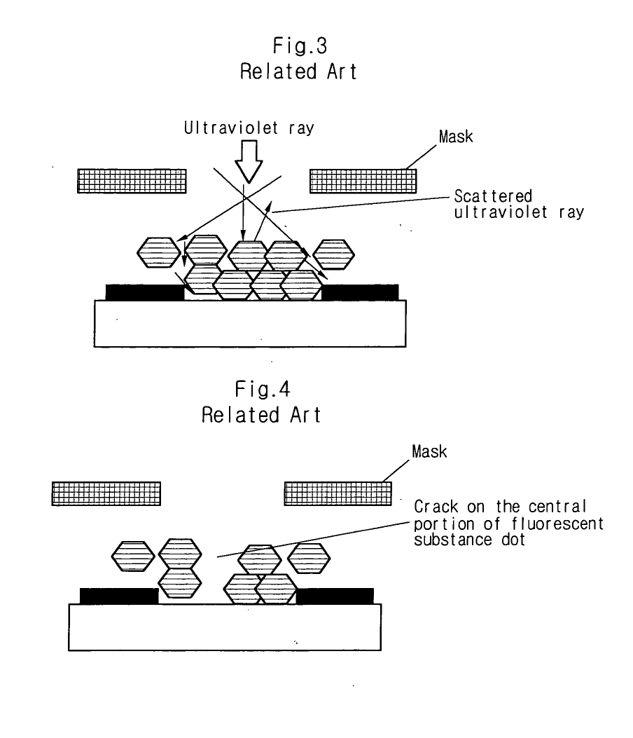

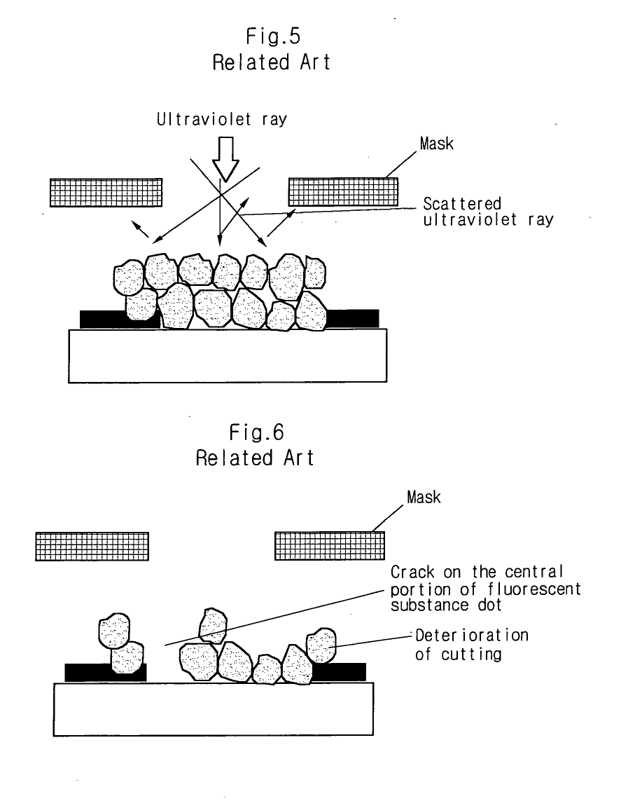

### DETAILED DESCRIPTION OF PREFERRED EMBODIMENTS

The following detailed description will present a fluorescent substance for a display device according to a preferred embodiment of the invention in reference to the accompanying drawings.

According to an embodiment of the invention, pigments are attached to red and blue fluorescent substances, and reflectivity thereof at 550 nm wavelength area ranges from 20 to 50%.

At this time, particle size of the pigments is in a range of 100-240 nm. When the particle size of the pigment is less than 100 nm, the pigments do not easily attach to the fluorescent substance, and they are either come off, or not uniformly attached to the surface of the fluorescent substance. Moreover, when the particle size is too small, it is not easy to adjust reflectivity at different wavelengths.

On the other hand, when the particle size of the pigment is greater than 240 nm, during an exposure process a fluorescent screen could be cracked by scattered lights.

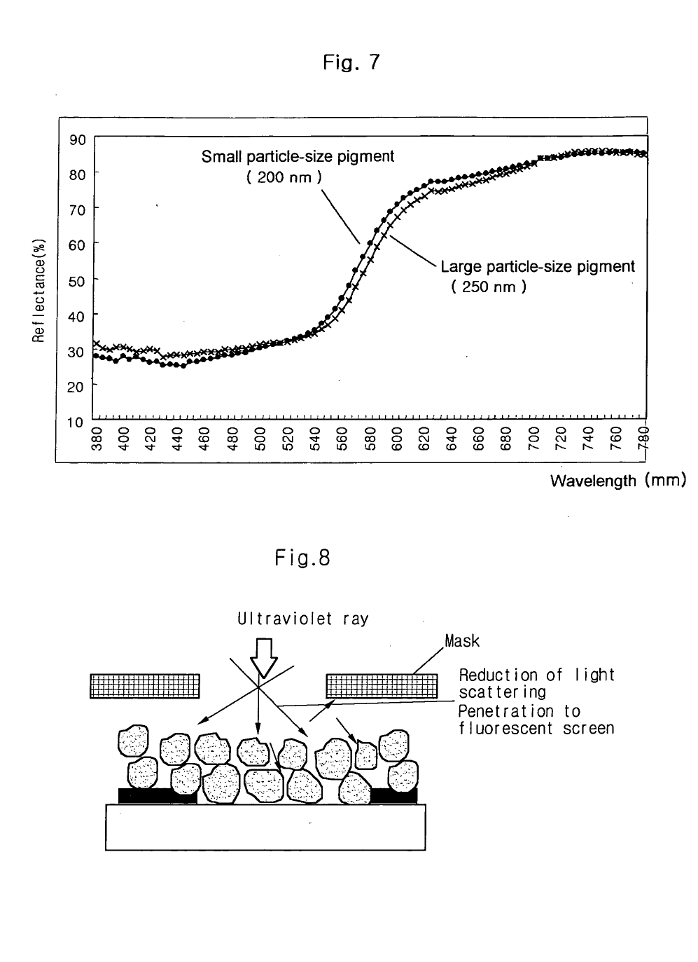

FIG. 7 graphically depicts a relation between reflectivity and wavelength, in which the particle size of red color pigment ranges from 100 to 240 nm (in FIG. 7, the particle size is 200 nm). Compared to a pigment with the particle size of 250 nm, the pigment of the invention exhibits an excellent spectrum.

In other words, at a 620 nm wavelength area which is a light-emitting peak area for the red fluorescent substance, the red color pigment having the particle size of 200 nm has a higher reflectivity than the red color pigment having the particle size of 250 nm. But in other color areas, reflectivity is low.

For example, the reflectivity at the light-emitting peak area for the red fluorescent substance can be lowered from 75% to about 25% at a 450 nm wavelength area, resulting in a selective adjustment of the reflectivity by approximately 50%.

In the meantime, when the particle size of the red color pigment is 250 nm, the effect of the selective adjustment on the reflectivity is reduced to about 40%.

According to the embodiment of the present invention, colloidal silica has a particle size of 8-40 nm. Also, particle size of silicon dioxide included in the colloidal silica is also in a rage of 8-40 nm.

When the particle size of the colloidal silica is less than 8 nm, work capacity is lowered and a mixing problem may occur. In addition, when the particle size of the colloidal silica is greater than 40 nm, cross linkage is weakened during the exposure process, caused by light scattering, and thus, the fluorescent substance can be cracked. Besides, when the particle size of the colloidal silica is great, adhesiveness of the fluorescent substance is reduced.

Table 2 below shows characteristics of colloidal silica with different particle sizes.

TABLE 2

| | Particle size of colloidal silica | | |
|---|---|---|---|
| Division | 1-8 nm | 8-40 nm | 40-120 nm |
| Adhesiveness | Excellent | Good | Poor |
| Mixing characteristic | Poor | Good | Good |
| Light scattering | Good | Good | Poor |
| Work capacity | Poor | Good | Good |

Therefore, coverage of the fluorescent substance can be improved by adjusting the size of pigments and the size of colloidal silica.

That is, by adjusting the size of pigments and the size of colloidal silica, light scattering is reduced, cross linkage is well made since ultraviolet rays are easily penetrated to the fluorescent screen, and cutting of the fluorescent substance is improved.

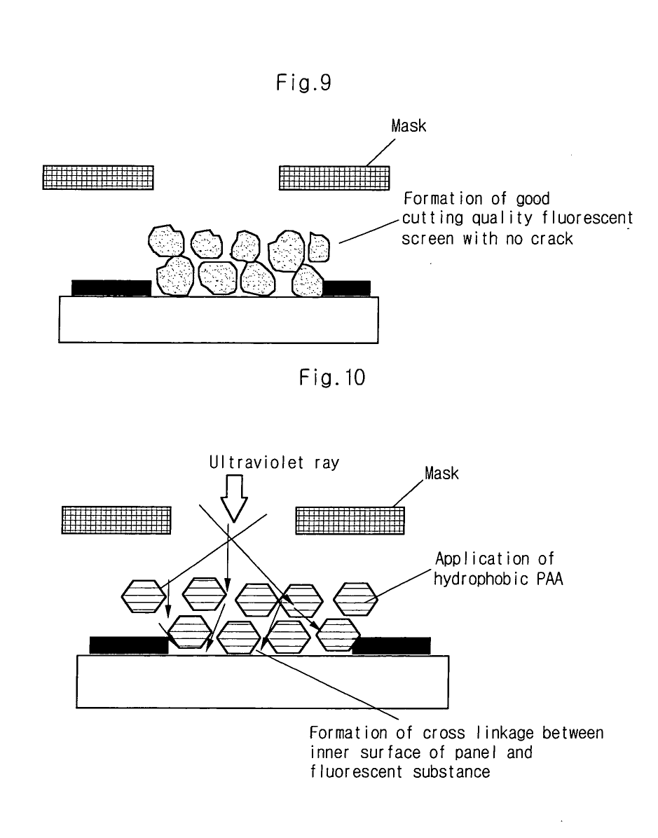

As a result, a good quality fluorescent screen is obtained, as shown in FIG. 9.

Although the fluorescent screen can be formed of pigment-rich fluorescent substance (low reflective fluorescent substance), it is possible to prevent crack on the fluorescent screen, and to secure a good coverage even with a shortened exposure time.

Further, to improve dispersion on the slurry, the present invention uses a hydrophobic type poly acryl acid, instead of the traditional hydrophilic type HPC.

In the embodiment, poly acrylic acid content is in a range of 5-60 g per 1 kg of the fluorescent substance.

When poly acrylic acid is applied with the above amount, dispersion between fluorescent substances on the slurry is improved, and precipitation speed of the slurry is lowered compared to that of the related art fluorescent substance, whereby a roughly packed fluorescent screen illustrated in FIG. 10 can be formed.

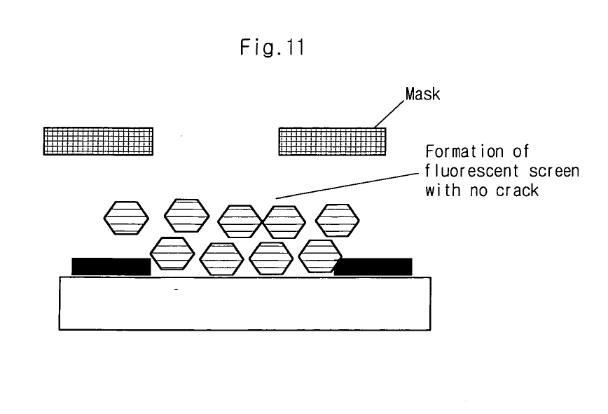

The roughly packed fluorescent screen demonstrates excellent exposure characteristics and cross linkage between an inner surface of the panel and the fluorescent substance. Thus, a fluorescent screen with no crack as shown in FIG. 11 can be formed.

Table 3 shows materials for surface treatment of the fluorescent substance and content thereof.

TABLE 3

| Gelatin | Arabic Gum | Silica | ZnSO₄ (20%) | HPC |
|---|---|---|---|---|
| 0.1-0.5 g | 0.05-0.2 g | 0.01-0.1% | — | 5-60 g |

Comparing Table 3 to Table 1, the amounts of binders used in attachment of the pigment, namely gelatin, Arabic gum, and silica, have been reduced. As a result, work capacity of the slurry, i.e. mesh passing ability, is greatly improved.

Besides, mixing or cracks are found much less, and defects in foam or solid are noticeably reduced.

Also, by excluding a traditionally used inorganic treatment material like an iron group material (i.e. ZnSO₄), the fluorescent substance is much less cracked due to light scattering and light absorption.

Accordingly, work capacity and coverage of the fluorescent substance can be secured and manufacturing defects can be much reduced, by adjusting materials for surface treatment, and particle size, content, and kind of pigments.

Table 4 shows a comparison result of the related art fluorescent substance (comparison example) to the fluorescent substance of the invention (invention example).

TABLE 4

| | | | | | | | | Work | | |
|---|---|---|---|---|---|---|---|---|---|---|
| | | | | | | | | capacity | | |
| | | | | Optical characteristic | | | | Mess | | |
| | Coverage | | | | Color | Bright | White | passing | Yield | |
| Division | Crack | Mixing | Cutting | Brightness | purity | uniformity | uniformity | ability | Solid | Foam |
| Comparison | B | B | B+ | 100% | 100% | 90% | 90% | Poor | Poor | Poor |
| Example | | | | | | | | | | |
| Invention | B+ | A | A | 103% | 105% | 95% | 95% | Good | Good | Good |
| Example | | | | | | | | | | |

As shown in Table 4, the present invention is superior to the related art fluorescent substance in every aspect including coverage, optical characteristics, work capacity, and yield.

In conclusion, the fluorescent substance of the present invention can be advantageously used for a display device, a cathode ray tube for example, in which electrons emitted from a cathode collide with the fluorescent screen formed on an anode by an accelerated applied voltage, and a designated image is displayed.

While the invention has been shown and described with reference to certain preferred embodiments thereof, it will be understood by those skilled in the art that various changes in form and details may be made therein without departing from the spirit and scope of the invention as defined by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

1. A fluorescent substance for a display device for displaying a desired image when electrons emitted from a cathode collide with a fluorescent screen formed on an anode by an accelerated applied voltage, wherein colloidal silica is formed on a surface of the fluorescent substance, and the colloidal silica content of the fluorescent substance is in a range of 0.01-0.1% by mass.

2. The fluorescent substance according to claim 1, wherein the colloidal silica includes silicon dioxide, and particle size of the silicon dioxide is in a range of 8-40 nm.

3. The fluorescent substance according to claim 1, wherein poly acrylic acid (PAA) is formed on the surface of the fluorescent screen, and the PAA content of 1 kg of the fluorescent substance is in a range of 5-60 g.

4. The fluorescent substance according to claim 1, wherein a pigment is attached to a red fluorescent substance or a blue fluorescent substance among the fluorescent substance.

5. The fluorescent substance according to claim 4, wherein reflectivity of the red fluorescent substance at a 550 nm wavelength is in a range of 20-50%.

6. The fluorescent substance according to claim 4, wherein reflectivity of the blue fluorescent substance at a 550 nm wavelength is in a range of 20-50%.

7. The fluorescent substance according to claim 4, wherein size of the pigment attached to the surface of the fluorescent substance is in a range of 100-240 nm.

8. The fluorescent substance according to claim 4, wherein gelatin and Arabic gum are used to attach and glue the pigment to the surface of the fluorescent substance.

9. The fluorescent substance according to claim 8, wherein gelatin content of 1 kg of the fluorescent substance is in a range of 0.1-0.5 g.

10. The fluorescent substance according to claim 8, wherein Arabic gum content of 1 kg of the fluorescent substance is in a range of 0.05-0.2 g.

11. A fluorescent substance for a display device, wherein size of a pigment attached to a surface of the fluorescent substance is in a range of 100-240 nm, and particle size of colloidal silica is in a range of 8-40 nm.

12. The fluorescent substance according to claim 11, wherein the colloidal silica includes silica dioxide, and particle size of the silica dioxide is in a range of 8-40 nm.

13. The fluorescent substance according to claim 11, wherein content of the colloidal silica is in a range of 0.01-0.1% by mass.

14. The fluorescent substance according to claim 11, wherein poly acrylic acid (PAA) is formed on the surface of the fluorescent substance, and the poly acrylic acid content of 1 kg of the fluorescent substance is in a range of 5-60 g.

15. The fluorescent substance according to claim 11, wherein Arabic gum content being used for 1 kg of the fluorescent substance is in a range of 5-60 g.
